(19) United States
(12) Patent Application Publication
(10) Pub. No.: US 2016/0202551 A1
(43) Pub. Date: Jul. 14, 2016

(54) LIQUID CRYSTAL DISPLAY DEVICE AND METHOD OF MANUFACTURING THE SAME

(71) Applicant: Samsung Display Co., Ltd., Yongin-City (KR)

(72) Inventors: Jeong Ho LEE, Yongin-City (KR); Hyang Yul KIM, Yongin-City (KR); Jun Ho SONG, Yongin-City (KR)

(21) Appl. No.: 14/876,929

(22) Filed: Oct. 7, 2015

(30) Foreign Application Priority Data
Jan. 13, 2015 (KR) 10-2015-0006360

(51) Int. Cl. G02F 1/1335; G02F 1/1362; G02F 1/1368; G02F 1/1337

(52) U.S. Cl. CPC G02F 1/133528; G02F 1/1337; G02F 1/136209; G02F 1/1368; G02F 2001/133531; G02F 2001/136222

(57) ABSTRACT

A liquid crystal display device includes a lower display substrate, an upper polarizing plate and a liquid crystal layer between the lower display substrate and the upper polarizing plate. The lower display substrate includes a base substrate; a thin film transistor on the base substrate; and a color filter layer on the thin film transistor. The liquid crystal layer is disposed on the color filter layer of the lower display substrate. The upper polarizing plate is disposed on the liquid crystal layer and includes an insulating substrate, a polarizer and a protective layer which are sequentially stacked from the liquid crystal layer.

This application claims priority to Korean Patent Application No. 10-2015-0006360, filed on Jan. 13, 2015, and all the benefits accruing therefrom under 35 U.S.C. §119, the entire contents of which are incorporated herein by reference in their entirety.

### BACKGROUND

1. Field

The invention relates to a liquid crystal display device and a method of manufacturing the same.

2. Description of the Related Art

Generally, a liquid crystal display (“LCD”) device is a device in which an electric field having adjusted intensity is applied to a liquid crystal having anisotropic permittivity and disposed between two display substrates, such that an amount of light transmitted therethrough is adjusted, thereby obtaining a desired image signal. Such a LCD device includes two display substrates, a liquid crystal layer disposed therebetween, two polarizing plates attached to the two display substrates, respectively, and a backlight unit providing light to the two display substrates.

### SUMMARY

The invention is directed to a liquid crystal display device for which a thickness thereof is decreased and a method of manufacturing the same.

An exemplary embodiment of the invention provides a liquid crystal display device including: a lower display substrate including a lower base substrate, a thin film transistor on the lower base substrate, and a color filter layer on the thin film transistor; a liquid crystal layer on the color filter layer of the lower display substrate; and an upper polarizing plate on the liquid crystal layer. The upper polarizing plate includes an insulating substrate, a polarizer and a protective layer which are sequentially stacked from the liquid crystal layer.

The insulating substrate may include at least one of a polyethylene terephthalate (“PET”) film, a polyethylene naphthalate (“PEN”) film, polycarbonate (“PC”) and poly methyl methacrylate (“PMMA”).

The polarizer may include a polarizing film including poly vinyl alcohol.

The protective layer may include tri-acetyl-cellulose (“TAC”).

The upper polarizing plate may further include an alignment layer disposed at a side of the insulating substrate opposite to that of the polarizer. The alignment layer may be disposed between the liquid crystal layer and the insulating substrate of the upper polarizing plate.

The upper polarizing plate may be bonded to the lower display substrate in a laminating method.

The liquid crystal display device may further include a lower polarizing plate on a rear surface of the lower display substrate, opposite to a front surface of the lower display substrate on which the upper polarizing plate is disposed. The lower polarizing plate may have an absorption axis perpendicular to that of the upper polarizing plate.

The lower display substrate may further include disposed therein, a black matrix overlapping the thin film transistor on the lower base substrate.

Another exemplary embodiment of the invention provides a method of manufacturing a liquid crystal display device. The method includes providing a lower display substrate, comprising: forming a thin film transistor on a lower base substrate and forming a color filter layer on the thin film transistor; coating the color filter layer of the lower display substrate with a liquid crystal; providing an upper polarizing plate and bonding the lower display substrate having the liquid crystal coated thereon to an upper polarizing plate. The providing an upper polarizing plate includes sequentially disposing a polarizer and a protective layer on a front surface of an insulating substrate.

The bonding the lower display substrate to the upper polarizing plate may include a laminating method.

The providing an upper polarizing plate may include, before the bonding the upper polarizing plate to the lower display substrate, forming an alignment layer on a rear surface of the insulating substrate of the upper polarizing plate, the rear surface opposite to the front surface on which the polarizer and the protective layer are sequentially disposed.

The insulating substrate of the upper polarizing plate may include at least one of a polyethylene terephthalate (“PET”) film, a polyethylene naphthalate (“PEN”) film, polycarbonate (“PC”) and poly methyl methacrylate (“PMMA”).

The polarizer of the upper polarizing plate may include a poly vinyl alcohol (“PVA”)-based polarizing film.

The protective layer of the upper polarizing plate may include tri-acetyl-cellulose (“TAC”).

The providing a lower display substrate may further include forming a black matrix overlapping the thin film transistor on the lower base substrate.

The method may further include bonding a lower polarizing plate to a rear surface of the lower display substrate, the rear surface opposite to a front surface of the lower display substrate on which the upper polarizing plate is disposed. The lower polarizing plate may have an absorption axis perpendicular to that of the upper polarizing plate.

The bonding the lower display substrate having the liquid crystal coated thereon to the upper polarizing plate may include disposing the alignment layer, the insulating substrate, the polarizer and the protective layer of the upper polarizing plate in order from the liquid crystal.

In one or more exemplary embodiment described above, the liquid crystal display device according to the invention, an upper polarizing plate including a sequentially stacked structure of an insulating substrate, a polarizer and a protective layer is bonded to a thin film transistor array substrate, thereby obviating a separate upper substrate within the thin film transistor array substrate. Since the thin film transistor array substrate excludes the separate upper substrate, the overall thickness of the liquid crystal display device employing such thin film transistor array substrate is decreased, thereby easily realizing a thinner structure of the liquid crystal display device.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is a cross-sectional view schematically illustrating an exemplary embodiment of a liquid crystal display device according to the invention;

FIG. 2 is a cross-sectional view schematically illustrating an exemplary embodiment of a first polarizing plate in the liquid crystal display device shown in FIG. 1; and

FIGS. 3A to 3I are cross-sectional views illustrating an exemplary embodiment of a method of manufacturing a liquid crystal display apparatus.

### DETAILED DESCRIPTION

Advantages and features of the invention and methods of accomplishing the same may be understood more readily by reference to the following detailed description of the exemplary embodiments and the accompanying drawings.

Exemplary embodiments will now be described more fully hereinafter with reference to the accompanying drawings. However, the invention may be embodied in different forms and should not be construed as limited to the exemplary embodiments set forth herein. Rather, these exemplary embodiments are provided so that this disclosure will be thorough and complete, and will fully convey the scope of the invention to those skilled in the art. In the drawing figures, dimensions may be exaggerated for clarity of illustration. The same reference numerals throughout the specification refer to like elements.

It will be understood that when an element is referred to as being “between” two elements, it can be the only element between the two elements (e.g., “directly between”), or one or more intervening elements may also be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting of the invention. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

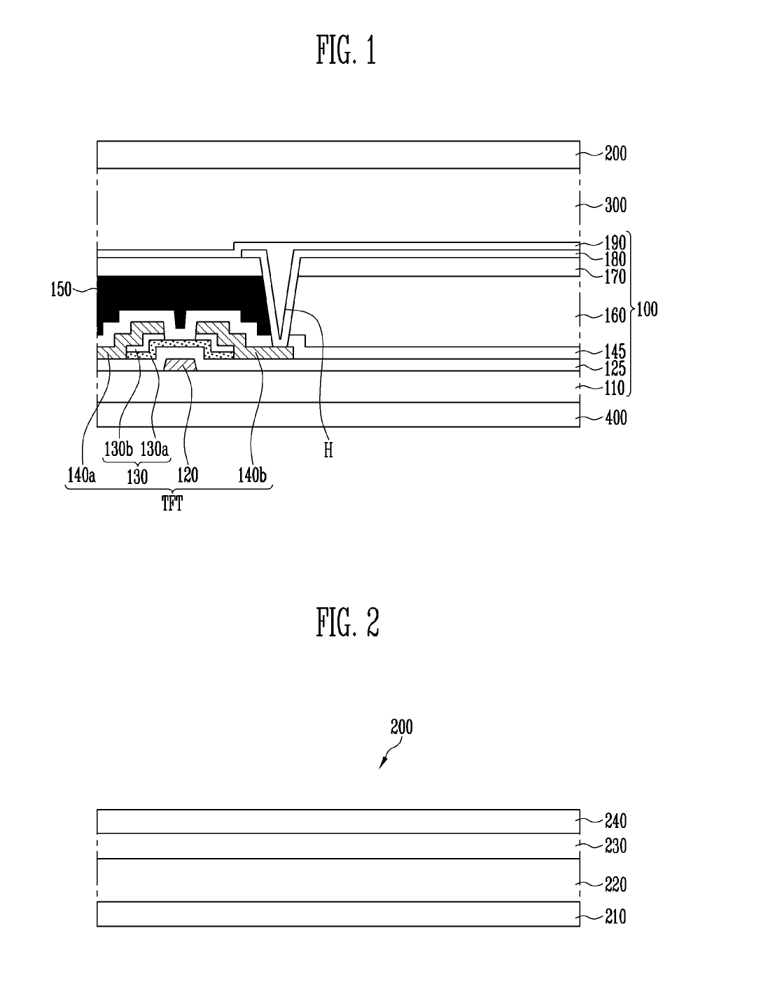

FIG. 1 is a cross-sectional view schematically illustrating an exemplary embodiment of a liquid crystal display device according to the invention.

Referring to FIG. 1, the liquid crystal display device includes a thin film transistor array (display) substrate 100, a first polarizing plate 200 disposed on a front surface of the thin film transistor array substrate 100, a second polarizing plate 400 disposed on a rear surface of the thin film transistor array substrate 100 opposite to the front surface thereof, and a liquid crystal layer 300 disposed between the thin film transistor array substrate 100 and the first polarizing plate 200.

The thin film transistor array substrate 100 includes a first (base) substrate 110, a plurality of thin film transistors (“TFTs”) disposed on the first substrate 110, a plurality of pixel electrodes 180 electrically coupled to the TFTs, and a first alignment layer 190 disposed on the pixel electrodes 180.

Also, the thin film transistor array substrate 100 further includes a black matrix 150, a color filter layer 160 and a planarization layer 170 which are disposed on the TFTs.

The TFTs each includes a gate electrode 120 disposed on the first substrate 110, a gate insulating layer 125 disposed on the gate electrode 120, a semiconductor layer 130 disposed on the gate insulating layer 125, and a source electrode 140a and a drain electrode 140b which are disposed on the semiconductor layer 130.

The semiconductor layer 130 includes an active layer 130a including an amorphous silicon material and an ohmic contact layer 130b including an impurity-doped amorphous silicon material which are sequentially stacked on one another.

A passivation layer 145 is disposed on the source electrode 140a and the drain electrode 140b of the TFT. The black matrix 150 overlapping the TFT and the color filter layer 160 corresponding to the pixel electrode 180 are each disposed on the passivation layer 145.

The planarization layer 170 which provides a planarized surface is disposed on the black matrix 150 and the color filter layer 160. A contact hole H may be defined in each of the passivation layer 145, and the planarization layer 170. The pixel electrode 180 which is electrically connected to the drain electrode 140b of the TFT through the contact hole H is disposed on the planarization layer 170.

Such a thin film transistor array substrate 100 has a black matrix on array (“BOA”) structure in which the TFTs and the black matrix 150 are disposed on one first substrate 110 or has a color filter on array (“COA”) structure in which the TFTs and the color filter layer 160 are disposed on one first substrate 110.

The first polarizing plate 200 is disposed on the thin film transistor array substrate 100. As shown in FIG. 2, the first polarizing plate includes an insulating second substrate 220 such as a plastic substrate, a polarizer 230, and a polarization protective layer 240 which are sequentially stacked on one another.

The plastic second substrate 220 may include a synthetic resin having an excellent mechanical strength, an excellent tensile strength, an excellent impact strength and/or excellent heat resistance.

The synthetic resin may include a polyethylene terephthalate (“PET”) film, a polyethylene naphthalate (“PEN”) film, polycarbonate (“PC)”, poly methyl methacrylate (“PMMA”), etc.

The polarizer 230 is disposed on the plastic second substrate 220. In a method of manufacturing the first polarizing plate 200, the polarizer 230 may be formed by iodine-dyeing a poly vinyl alcohol (“PVA”) film and elongating the dyed PVA film in a predetermined direction. Such a polarizer 230 absorbs light in an elongation direction, and transmits light in a direction perpendicular to the elongation direction, thereby polarizing the light.

The polarization protective layer 240 is disposed on the polarizer 230 and protects the polarizer 230.

The first polarizing plate 200 further includes a second alignment layer 210 disposed under the plastic second substrate 220. The second alignment layer 210 functions to pre-tilt liquid crystal molecules of the liquid crystal layer 300 at a predetermined angle along with the first alignment layer 190 disposed within the thin film transistor array substrate 100.

The first polarizing plate 200 may be bonded to the thin film transistor array substrate 100 such as in a laminating method, etc. to dispose the liquid crystal layer 300 therebetween. Since the first polarizing plate 200 includes the second substrate 220 including a plastic material, the first polarizing plate 200 may also function as an upper substrate of the liquid crystal display device while the first substrate 110 functions as a lower substrate thereof.

That is, the thin film transistor array substrate 100 is formed in the BOA structure in which the TFTs and the black matrix 150 are disposed on one lower first substrate 110 included or the COA structure in which the TFTs and the color filter layer 160 are disposed on the one lower first substrate 110, and the upper substrate (e.g., the second substrate 220) does not include a color filter layer or a black matrix disposed thereon.

Thus, in the liquid crystal display device, the first polarizing plate 200 may function as the upper substrate.

Therefore, in an alternative exemplary embodiment of the invention, an additional upper substrate as a constituent element of a thin film transistor array substrate may be omitted in favor of a single one lower substrate, and thus, an overall thickness of the liquid crystal display device may be decreased, thereby realizing a thinner structure thereof.

Also, since the TFTs and the color filter layer 160 are all included within the thin film transistor array substrate 100, quality degradation caused by misalignment of elements disposed on two separate substrates may be reduced or effectively prevented.

Hereinafter, a method of manufacturing the liquid crystal display device having the above-mentioned structure according to the invention will be described.

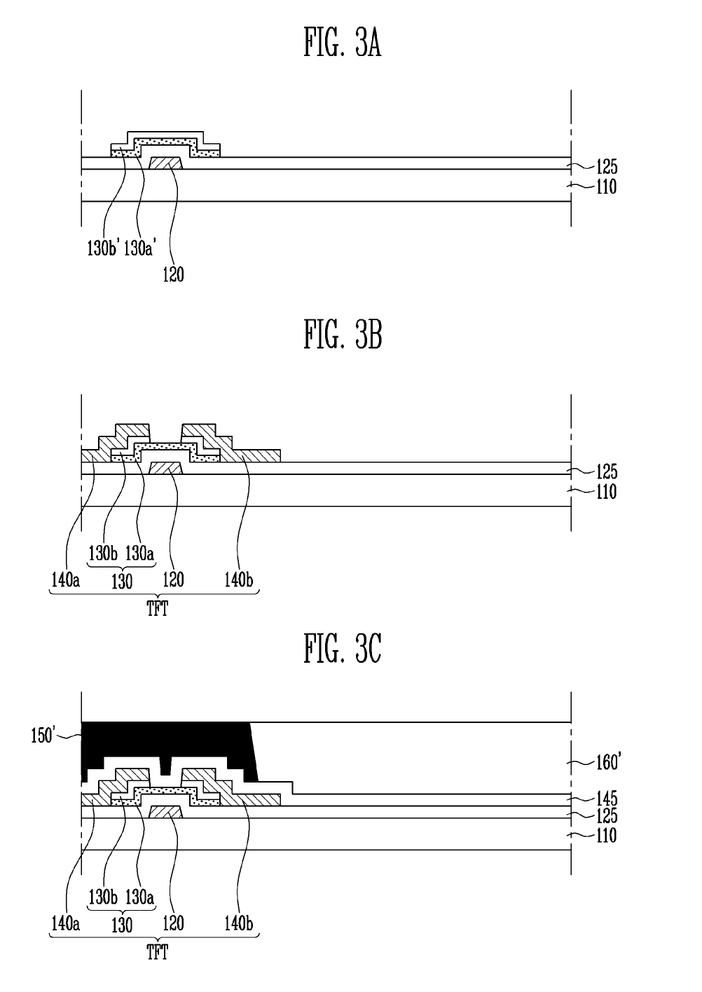

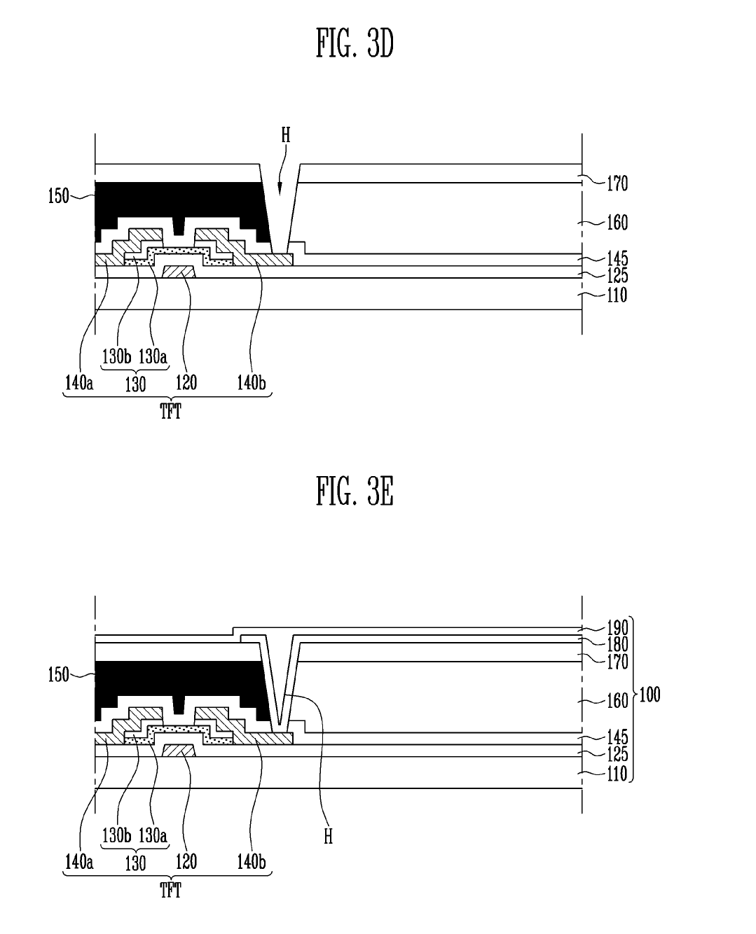

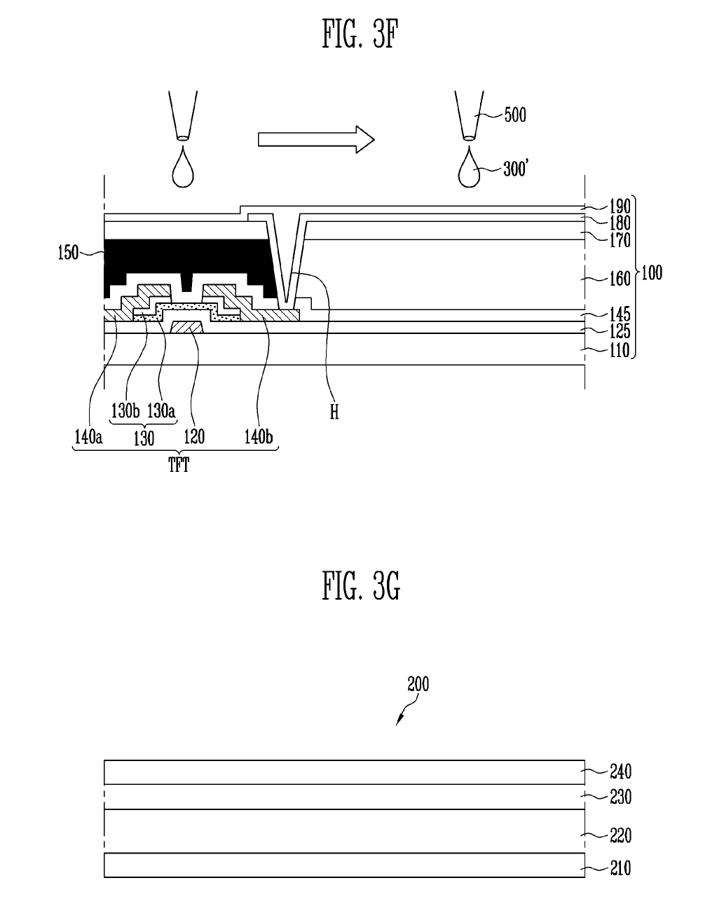

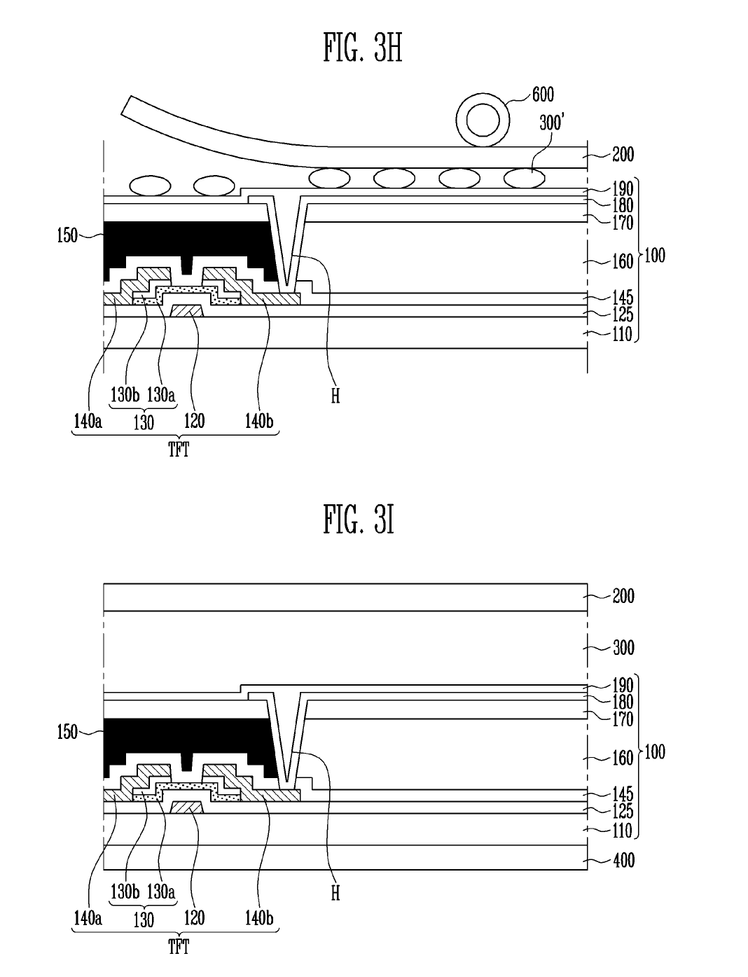

FIGS. 3A to 3I are cross-sectional views sequentially illustrating an exemplary embodiment of a method of manufacturing a liquid crystal display apparatus, such as the one shown in FIG. 1.

Referring to FIG. 3A, a gate electrode 120 is formed on a first substrate 110, and a gate insulating layer 125 is formed on the gate electrode 120. A material having an excellent mechanical strength and excellent dimensional stability and used to form a device may be selected for the first substrate 110. Examples of the material of the first substrate 110 may include a glass plate, a metal plate, a ceramic plate, or a plastic (polycarbonate resin, polyester resin, epoxy resin, silicon resin, fluorine resin, etc.), but are not limited thereto.

The gate electrode 120 may be formed of a single-layered structure or a multilayer (stacked) layer structure using a first conductive material. The first conductive material may include a metal such as molybdenum, titanium, chromium, tantalum, tungsten, aluminum, copper, neodymium, scandium, or an alloy thereof, thereby forming a conductive layer. After the first conductive material layer is formed on an entire surface of the first substrate 110, the first conductive material layer may be patterned to form the gate electrode 120. The patterning of the first conductive material layer may include a photolithography process including forming a photoresist layer pattern on the first conductive material layer and removing an unnecessary portion such as by etching, thereby forming the gate electrode 120.

When the gate electrode 120 is formed in the stacked layer structure, for example, the gate electrode 120 may include any one selected from a double-layered structure of a molybdenum layer stacked on an aluminum layer, a double-layered structure of a molybdenum layer stacked on a copper layer, a double-layered structure of a tantalum nitride layer stacked on a copper layer or a double-layered structure of stacking tantalum nitride, and a double-layered structure of a molybdenum layer stacked on a tantalum nitride layer.

The gate insulating layer 125 is formed as a single-layered structure or a stacked-layer structure using an inorganic insulating material layer such as a silicon oxide layer, a silicon oxide nitride layer, a silicon nitride oxide layer, a silicon nitride layer, and a tantalum oxide layer, etc.

An amorphous silicon material layer 130a′ and an impurity-doped amorphous silicon material layer 130b′ corresponding to the gate electrode 120 are formed on the gate insulating layer 125.

Then, referring to FIG. 3B, a second conductive material layer (not shown) is deposited on the impurity-doped amorphous silicon material layer 130b′, and a mask process is performed to pattern the second conductive material layer. A source electrode 140a and a drain electrode 140b which are spaced a constant interval from each other are formed from the patterned second conductive material layer.

Simultaneously, an ohmic contact layer 130b disposed under the source electrode 140a and the drain electrode 140b, of which portions are spaced apart from each other to correspond to the source and drain electrodes 140a and 140b is formed. An active layer 130a which is exposed to outside the source electrode 140a, the drain electrode 140b and the ohmic contact layer 130b is formed. The exposed portion of the active layer 130a serves as a channel of the TFT.

The ohmic contact layer 130b and the active layer 130a collectively form the semiconductor layer 130. The gate electrode 120, the semiconductor layer 130, and the source electrode 140a and the drain electrode 140b which are sequentially formed on the first substrate 110, collectively form the TFT.

Here, the source electrode 140a and the drain electrode 140b may be formed as a single layer (e.g., monolayer) structure of a single material or a combination of materials selected from molybdenum (Mo), tungsten (W), aluminum neodymium (AlNd), titanium (Ti), aluminum (Al), silver (Ag), and an alloy thereof. The source electrode 140a and the drain electrode 140b may be formed as a double layer or a multilayer structure layer selected from monolayers of molybdenum (Mo), aluminum (Al) or silver (Ag) which is a low resistive material to decrease line resistance.

That is, in order to decrease electrical resistance of a signal line of the liquid crystal display such as a gate or data conductor or a gate or data line of which portions define elements such as the gate, source or drain electrodes described above, the source electrode 140a and the drain electrode 140b may be formed by sequentially stacking conductive layers in a multilayer structure. In particular, the source electrode 140a and the drain electrode 140b may have a multilayer structure formed of Mo/Al/Mo, MoW/AlNd/MoW, Mo/Ag/Mo, Mo/Ag-alloy/Mo, or Ti/Al/Mo.

Referring to FIG. 3C, a protective layer 145 is formed on the TFT, and a black matrix material layer 150′ overlapping the TFT is formed on the protective layer 145, and a color material layer 160′ corresponding to a pixel electrode 180 (shown in FIG. 1) to be formed by a later process is formed.

The protective layer 145 may include an insulating material selected from an inorganic insulating material and an organic insulating material.

The black matrix material layer 150′ may include an organic material including carbon black, etc. The black matrix material layer 150′ may be patterned such as through a photolithography process after coating the first substrate 110 with the organic material.

A photosensitive resin in which colorants are distributed may be used as a color material layer 160′. The color material layer 160′ may be formed on a portion of the first substrate 110 on which the black matrix material layer 150′ is not formed such as by selectively exposing a photosensitive resin using a mask, and then, developing the exposed the photosensitive resin using a developer.

Referring to FIG. 3D, a planarization layer 170 is formed on the black matrix material layer 150′ and the color material layer 160′. The planarization layer 170, the black matrix material layer 150′, the color material layer 160′ and the protective layer 145 are each patterned to finally form a black matrix 150, a color filter layer 160 and a contact hole H defined by the planarization layer 170, the black matrix 150, the color filter layer 160 and the protective layer 145, where the contact hole partially exposes the drain electrode 140b of the TFT.

Referring to FIG. 3E, a third conductive layer (not shown) is formed on an entire surface of the first substrate 110 in which the contact hole H is formed, and the third conductive layer (not shown) is patterned to form a pixel electrode 180 electrically coupled to the drain electrode of the TFT via the contact hole H. The pixel electrode 180 may include a transparent metal material such as indium tin oxide (“ITO”) or indium zinc oxide (“IZO”).

A first alignment layer 190 configured to pretilt liquid crystal molecules of a liquid crystal layer 300 adjacent thereto (shown in FIG. 1) at a predetermined angle is formed on an entire surface of the first substrate 110 with the pixel electrode 180 thereon.

The first substrate 110, the TFTs, the black matrix 150, the color filter layer 160, the pixel electrode 180 and the first alignment layer 190 form the thin film transistor array substrate 100 including a single base substrate.

Referring to FIG. 3F, a liquid crystal material 300′ is dropped on the formed thin film transistor array substrate 100 such as by using a nozzle 500. A dispenser such as the nozzle 500 may be used as a device configured to drop the liquid crystal material 300′ on the thin film transistor array substrate 100.

Referring to FIG. 3G, a first polarizing plate 200 in which a second alignment layer 210, an insulating substrate 220 such as a plastic substrate, a polarizer 230 and a polarization protective layer 240 are sequentially stacked is prepared.

The second alignment layer 210 is formed on a rear surface of the plastic substrate 220, and faces the first alignment layer 190 of the thin film transistor array substrate 100 to have the liquid crystal layer 300 disposed therebetween (shown in FIG. 1).

The polarizer 230 may include a poly vinyl alcohol (“PVA”)-based film. Specifically, the polarizer 230 is formed by elongating a PVA film, and then, dipping the PVA film in a solution of iodine (12) and a dichromatic dye to align iodine molecules and dichromatic dye molecules parallel to the elongation direction of the PVA film. Since the iodine molecules and the dye molecules have dichroism, the polarizer 230 absorbs light vibrating in the elongation direction and transmits light vibrating in a direction perpendicular to the elongation direction.

Here, the plastic substrate 220 and the polarizer 230 may be coupled to each other by an adhesive (not shown), but the invention is not limited thereto. The adhesive (not shown) may include a polyurethane-based adhesive.

The polarization protective layer 240 is disposed on the polarizer 230, and includes a material having transparency, excellent mechanical strength, excellent thermal stability, excellent water repellency and excellent isotropy.

Detailed examples of the polarization protective layer 240 may include a polyester-based film such as polyethylene terephthalate, polyethylene isophthalate, polyethylene naphthalate, polybuthylene terephthalate, etc.; a cellulose-based film such as diacetyl cellulose, butyryl cellulose, acetylpropionyl cellulose, etc.; a polycarbonate film; an acryl based film such as polymethyl methacrylate, polyethyl methacrylate, etc.; a styrene-based film such as polystyrene, an acrylonitrile-styrene copolymer, etc.; a polyonefin-based film such as polyethylene, polypropylene, a polyolefin based film having a cyclo-based structure or a norbornene structure, an ethylene propylene copolymer, etc.; an ethylene-acetic acid vinyl copolymer film; a polyamide film; a polyimide film, a polyetherimide film; a polyethersulfone-based film; a polyvinylchloride film, a polyvinylidenechloride film; a polyvinylalcohol film, a polyvinylacetal film; a polyurethane film, an epoxy film, etc. The above may be used as a non-elongation film, a 1-axis elongation film, or a 2-axis elongation film. In exemplary embodiments, among the above, the polarization protective layer 240 includes a 1-axis elongation polyester film or a 2-axis elongation polyester film, a polymethylmethacrylate film, or a polycycloolefin-based film which has excellent transparency and excellent thermal resistance, or triacetylcellulose (“TAC”) which has transparency but does not have optical anisotropy.

An outer surface of the polarization protective layer 240 exposed outside the liquid crystal display device may be surface treated (e.g., anti glare or anti reflection treatment).

Referring to FIG. 3H, the first polarizing plate 200 is bonded to the TFT array substrate 100 coated with the liquid crystal material 300′ such as in a laminating process in which a pressure is applied using a roller 600. Thus, the liquid crystal layer 300 as shown in FIG. 3I is finally formed from the liquid crystal material 300′ and disposed between the thin film transistor array substrate 100 and the first polarizing plate 200.

The first polarizing plate 200, and a second polarizing plate 400 which has a light absorption axis (or a transmission axis) perpendicular to that of the first polarizing plate 200, are respectively attached to outer surfaces of the thin film transistor array substrate 100.

Since the thin film transistor array substrate 100 has a black matrix on array (“BOA”) structure or a color filter on array (“COA”) structure, the first polarizing plate 200 including the plastic substrate 220 may also function as an upper substrate of the thin film transistor array substrate 100.

Since the first polarizing plate 200 is bonded to the thin film transistor array substrate 100 to have the liquid crystal layer 300 therebetween, and also functions as the upper substrate of the thin film transistor array substrate 100, an additional upper substrate within the thin film transistor array substrate 100 may be omitted. By omitting the additional (third) substrate within the thin film transistor array substrate 100, an overall thickness of the liquid crystal display device is decreased and a thinner structure of the liquid crystal display device is realized.

By way of summation and review, since use the liquid crystal display device is rapidly increasing such as in use a relatively slim type portable display device, etc., decreasing an overall thickness of the liquid crystal display device is desired.

In one or more exemplary embodiment described above, the liquid crystal display device according to the invention, an upper polarizing plate including a sequentially stacked structure of a plastic substrate, a polarizer and a protective layer is bonded to a thin film transistor array substrate, thereby obviating a separate upper substrate within the thin film transistor array substrate.

Since the thin film transistor array substrate excludes the separate upper substrate, the overall thickness of the liquid crystal display device employing such thin film transistor array substrate is decreased, thereby easily realizing a thinner structure of the liquid crystal display device.

Also, in one or more exemplary embodiment of the liquid crystal display device according to the invention, the TFT and the color filter layer are formed within a same display substrate on a same base substrate, thereby preventing misalignment thereof.

Exemplary embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention as set forth in the following claims.

What is claimed is:

1. A liquid crystal display device comprising:
a lower display substrate comprising:
a lower base substrate;
a thin film transistor on the lower base substrate; and
a color filter layer on the thin film transistor;
a liquid crystal layer on the color filter layer of the lower display substrate; and
an upper polarizing plate on the liquid crystal layer, the upper polarizing plate comprising an insulating substrate, a polarizer and a protective layer which are sequentially disposed from the liquid crystal layer.

2. The liquid crystal display device of claim 1, wherein the insulating substrate of the upper polarizing plate comprises polyethylene terephthalate film, a polyethylene naphthalate film, polycarbonate or poly methyl methacrylate.

3. The liquid crystal display device of claim 1, wherein the polarizer of the upper polarizing plate comprises a polarizing film including poly vinyl alcohol.

4. The liquid crystal display device of claim 1, wherein the protective layer of the upper polarizing plate comprises tri-acetyl-cellulose.

5. The liquid crystal display device of claim 1, wherein the upper polarizing plate further comprises an alignment layer disposed at a side of the insulating substrate opposite to that of the polarizer, the alignment layer disposed between the liquid crystal layer and the insulating substrate of the upper polarizing plate.

6. The liquid crystal display device of claim 1, wherein the upper polarizing plate is laminated to the lower display substrate.

7. The liquid crystal display device of claim 1, further comprising a lower polarizing plate on a rear surface of the lower display substrate, opposite to a front surface of the lower display substrate on which the upper polarizing plate is disposed, the lower polarizing plate having an absorption axis perpendicular to that of the upper polarizing plate.

8. The liquid crystal display device of claim 1, wherein the lower display substrate further comprises disposed therein, a black matrix overlapping the thin film transistor on the lower base substrate.

9. A method of manufacturing a liquid crystal display device, comprising:
providing a lower display substrate, comprising:
providing a lower base substrate;
forming a thin film transistor on the lower base substrate; and
forming a color filter layer on the thin film transistor;
coating the color filter layer of the lower display substrate with a liquid crystal material;
providing an upper polarizing plate; and
bonding the lower display substrate including the liquid crystal coated thereon to the upper polarizing plate,
wherein the providing the upper polarizing plate comprises sequentially disposing a polarizer and a protective layer on a front surface of an insulating substrate.

10. The method of claim 9, wherein the bonding the lower display substrate to the upper polarizing plate comprises a laminating method.

11. The method of claim 9, wherein the providing the upper polarizing plate comprises, before the bonding the upper polarizing plate to the lower display substrate, forming an alignment layer on a rear surface of the insulating substrate of the upper polarizing plate, the rear surface opposite to the front surface on which the polarizer and the protective layer are sequentially disposed.

12. The method of claim 9, wherein the insulating substrate of the upper polarizing plate comprises at least one of a polyethylene terephthalate film, a polyethylene naphthalate film, polycarbonate and poly methyl methacrylate.

13. The method of claim 9, wherein the polarizer of the upper polarizing plate comprises a polarizing film including poly vinyl alcohol.

14. The method of claim 9, wherein the protective layer of the upper polarizing plate comprises tri-acetyl-cellulose.

15. The method of claim 9, wherein the providing a lower display substrate further comprises forming a black matrix overlapping the thin film transistor on the lower base substrate.

16. The method of claim 9, further comprising bonding a lower polarizing plate to a rear surface of the lower display substrate, the rear surface opposite to a front surface of the lower display substrate on which the upper polarizing plate is disposed, the lower polarizing plate having an absorption axis perpendicular to that of the upper polarizing plate.

17. The method of claim 11, wherein the bonding the lower display substrate having the liquid crystal coated thereon to the upper polarizing plate comprises disposing the alignment layer, the insulating substrate, the polarizer and the protective layer of the upper polarizing plate in order from the liquid crystal.
